(19) United States
(12) Patent Application Publication
(10) Pub. No.: US 2026/0240078 A1
(43) Pub. Date: Aug. 20, 2026

(54) CONTROLLING THE OPERATION OF A CROSS-AUGER

(71) Applicant: AGCO Corporation, Duluth, GA (US)

(72) Inventors: Benjamin Adam WELLE, Hesston, KS (US); Steve John Schrag, Hesston, KS (US)

(21) Appl. No.: 19/159,837

(22) PCT Filed: Jan. 23, 2024
(86) PCT No.: PCT/IB2024/050630

§ 371 Date: Aug. 26, 2025

Related U.S. Application Data
(60) Provisional application No. 63/488,250, filed on Mar. 3, 2023.

(51) Int. Cl. A01D 61/00; A01D 41/12; A01D 41/127; A01D 69/02; A01D 69/03; A01D 75/18

(52) U.S. Cl. CPC A01D 61/004; A01D 41/1217; A01D 41/1274; A01D 75/182; A01D 61/008; A01D 69/02; A01D 69/03

(57) ABSTRACT

A mechanism for controlling the operation of a cross auger conveyor for a grain bin. The cross auger conveyor is configured for moving grain towards an unloading auger system. A torque restriction system is configured to monitor a load torque of the cross auger conveyor and restrict or limit the load torque to be less than or equal to an adjustable predetermined maximum load torque.

### CROSS-REFERENCE TO RELATED APPLICATIONS

Not applicable.

### FIELD OF THE INVENTION

Embodiments of the present disclosure generally relate to the field of combine harvesting.

### BACKGROUND OF THE INVENTION

With ever-increasing population numbers and ongoing interest in more environmentally friendly farming practices, there is an increasing desire to reduce waste when harvesting crop and improve the efficiency of harvesting machinery, such as combine harvesters.

A combine harvester will harvest grain and store the harvested grain in a grain bin, which is sometimes called a grain tank. The stored grain needs to be periodically emptied (e.g., into a trailer pulled by a tractor or a grain store) as the grain bin fills. A typical combine harvester will make use of a pair of augers in order to move grain out of the grain bin. An unloading auger will move the grain from an intake, positioned inside the grain bin, to an outtake positioned outside the grain bin. A cross auger will move grain through the grain bin towards the intake for the unloading auger.

It has been recognized that different crops need to be unloaded at different flow rates to avoid or reduce damage to the unloading auger and/or the grain. Historically, this issue is addressed through the use of: gates that restrict the amount of grain that can enter the cross auger; gates that limit the flow of grain into the intake of the unloading auger; and/or speed control of the cross auger to control grain flow into the intake of the unloading auger. These systems all rely on an operator changing the combine setting(s) to compensate for the change.

There is an ongoing desire to improve the performance of a combine harvester and reduce the risk of damage to components of the combine harvester and/or any harvested grain.

### SUMMARY OF THE INVENTION

The invention is defined by the claims.

According to examples in accordance with an aspect of the invention, there is provided a cross auger system for moving grain across a grain bin towards an unloading auger system. The cross auger system comprises a cross auger conveyor configured to receive grain and move the received grain towards an unloading auger system; and a torque restriction system configured to monitor the load torque of the cross auger conveyor and restrict, responsive to the magnitude of the monitored load torque, the magnitude of the load torque to less than or equal to a predetermined maximum load torque, wherein the value of the predetermined maximum load torque is adjustable.

The proposed cross auger system is able to dynamically adapt to changes in load torque, to prevent the load torque of the cross auger conveyor from exceeding a predetermined maximum load torque.

Advantageously, the proposed approach will automatically adapt the speed of the cross auger for different weights of crop (e.g., if going from light crops to heavy crops or for crops with high moisture content) because different crop weights result in different torques at the same speed. This can prevent or reduce damage to the unloading auger system by effectively controlling the weight of crops that need to be lifted or move to prevent excess weight carrying by the unloading auger system.

Moreover, the proposed approach allows for automated control of speed responsive to the amount of grain carried by the cross auger conveyor. Thus, when the grain bin is full, grain will flow faster into the cross auger such that the cross auger conveyor can operate at a reduced speed. Similarly, when the bin is almost empty, less grain will flow into the cross auger, meaning that it can be sped up than current product to reduce cleanout time. A particular benefit of the proposed technique is that the feeding rate of grain to the unloading auger system (and therefore the overall unloading speed) is more consistent, as the speed of the cross auger system can dynamically adapt to changes in crop amount carried by the cross auger system, instead of having peak and average flow rates.

The torque restriction system is a system that is configured to respond to the load torque of the cross auger conveyor reaching or exceeding the predetermined maximum load torque and reduce the load torque below this predetermined maximum load torque. This can be achieved, for instance, by limiting the load torque to this predetermined maximum load torque by limiting the input power (e.g., fluid pressure or electrical power) of a motor for the cross auger conveyor.

The value of the predetermined maximum load torque is adjustable. Thus, the torque restriction system is able to receive an input for controlling or otherwise defining the predetermined maximum load torque. This may, for instance, be responsive to a user input.

The cross auger conveyor may comprise: at least one helical portion configured to receive grain; and a motor configured to controllably rotate each helical portion so as to control the movement of grain along each helical portion, wherein the load torque of the motor represents the load torque of the cross auger conveyor. This configuration provides a reliable mechanism for moving grain towards an unloading auger system.

In some examples, the motor is a hydraulically driven motor, wherein a hydraulic pressure provided to the hydraulically driven motor controls the rotation speed of each helical portion; and the torque restriction system is configured to reduce the hydraulic pressure provided to the hydraulically driven motor responsive to the magnitude of the monitored load torque approaching or reaching the predetermined maximum load torque.

For instance, the torque restriction system may comprise an electrically controlled relief valve configured to controllably reduce the hydraulic pressure responsive to the magnitude of the monitored load torque approaching or reaching the predetermined maximum load torque. This approach provides a mechanism for automated and reliable control over the load torque of the cross auger conveyor that can be easily integrated into existing combine harvester systems without significant modification to the complex hydraulic pressure system.

Put another way, the relief valve is capable of simultaneously performing the operations of monitoring the load torque and restricting the load torque when it exceeds a predetermined maximum load torque. The maximum load torque may be set using an electronic control of the relief valve (e.g., defining the torque above which pressure is relieved via the relief valve).

In some examples, the torque restriction system comprises a controllable flow regulator configured to control the hydraulic pressure provided to the hydraulically driven motor; and the flow regulator controls the hydraulic pressure responsive to the monitored load torque so as to restrict the magnitude of the load torque to less than or equal to the predetermined maximum load torque. This provides an alternative technique for controlling the load torque of the cross auger system that may provide a more compact torque restriction system, as flow regulators are commonly used in existing hydraulic pressure systems.

The torque restriction system may comprise a hydraulic pressure monitor configured to monitor, as a measure of the load torque, the hydraulic pressure provided to the hydraulically driven motor. The use of such a pressure monitor is particularly useful if a flow regulator is used to control the hydraulic pressure (to avoid the torque exceeding a maximum load torque).

In some examples, the motor is an electrically driven motor; and the torque restriction system is configured to reduce the power provided to the electrically driven motor responsive to the magnitude of the load torque approaching or reaching the predetermined maximum load torque.

The torque restriction system may comprise one or more strain sensors for monitoring the load torque of the motor. Other suitable forms of sensors for monitoring a load torque would be apparent to the skilled person.

Preferably, in use, the cross auger conveyor lies in a horizontal plane.

There is also proposed a grain unloading system comprising any herein described cross auger system; and an unloading auger system comprising: an intake configured to receive grain moved by the cross auger; an outlet for expelling grain from the unloading auger; and an unloading auger conveyor for moving grain from the intake to the outlet.

The grain unloading system may further comprise the grain bin for holding grain. In some examples, the cross auger conveyor of the cross auger system is housed within the grain bin; the intake of the unloading auger system is located within the grain bin; and the outlet of the unloading auger system is located outside of the grain bin.

The grain unloading system may further comprise a housing that houses the entirety of the unloading auger conveyer and defines the intake and outlet.

There is also proposed a combine harvester comprising any herein described cross auger system and/or grain unloading system.

There is also provided a method for controlling the operation of a cross auger system for moving grain across a grain bin towards an unloading auger, wherein the cross auger system comprises a cross auger conveyor configured to receive grain and move the received towards an unloading auger system.

The method comprises monitoring the load torque of the cross auger conveyor; and restricting the magnitude of the load torque to less than or equal to a predetermined maximum load torque. It will be appreciated that, in some methods, these two steps are performed simultaneously in that a torque is automatically and immediately reduced when the torque (or a parameter that changes together with torque) reaches some threshold.

The value of the predetermined maximum load torque is adjustable.

These and other aspects of the invention will be apparent from and elucidated with reference to the embodiment(s) described hereinafter.

### BRIEF DESCRIPTION OF THE DRAWINGS

One or more embodiments of the invention/disclosure will now be described, by way of example only, with reference to the accompanying drawings, in which:

FIG. 1 illustrates a combine harvester which may be adapted in accordance with embodiments;

FIG. 2 illustrates a portion of a combine harvester;

FIG. 3 illustrates an example of grain unloading apparatus;

FIG. 4 conceptually illustrates a portion of grain unloading apparatus;

FIG. 5 illustrates a control system for a cross auger system;

FIG. 6 illustrates an alternative control system for a cross auger system; and

FIG. 7 is a flowchart illustrating a proposed method.

### DETAILED DESCRIPTION OF THE EMBODIMENTS

The invention will be described with reference to the figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the figures are merely schematic and are not drawn to scale. It should also be understood that the same reference numerals are used throughout the figures to indicate the same or similar parts.

The invention provides a mechanism for controlling the operation of a cross auger conveyor. The cross auger conveyor is configured for moving grain towards an unloading auger system. A torque restriction system is configured to monitor a load torque of the cross auger conveyor and restrict or limit the load torque to be less than or equal to a predetermined maximum load torque.

Embodiments are based on the realization that the load torque of a cross auger conveyor controls the amount of grain or crop passed to an unloading auger system. By restricting the load torque to a maximum, damage to the unloading auger system can be avoided by preventing the unloading auger system from bearing an extremely heavy weight. Proposed approaches also facilitate dynamic control based on the amount of grain present in the cross auger system for improved consistency of grain unloading.

Herein disclosed approaches can be employed in combine harvesters, particularly in the grain unloading system of a combine harvester.

This disclosure relates to the design of the grain unloading system, particularly to the movement of grain within the grain bin. However, a general outline of a combine harvester will first be provided.

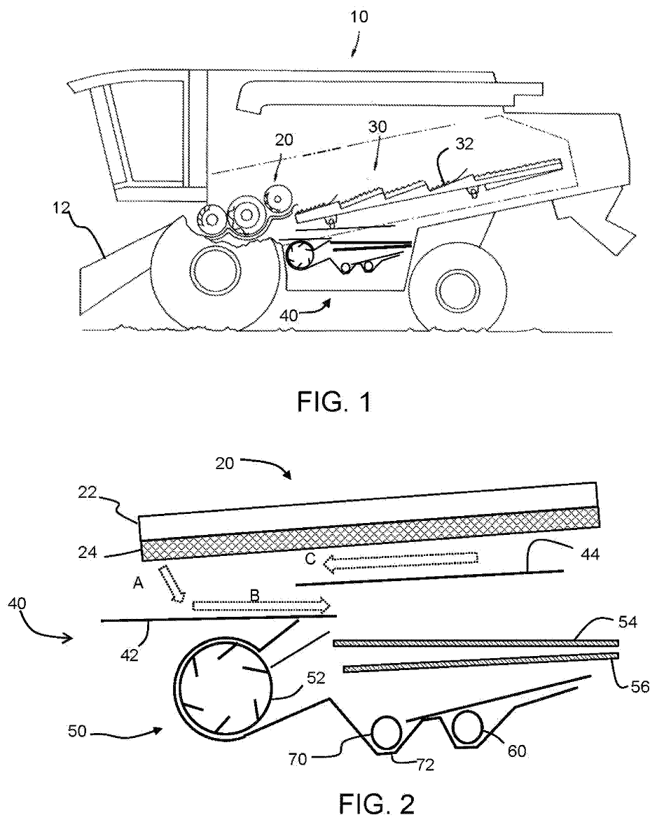

FIG. 1 conceptually illustrates a combine harvester 10, for improved contextual understanding.

FIG. 1 shows a known combine harvester 10 in which embodiments may be integrated. The combine harvester includes a threshing unit 20 for detaching grains of cereal from the ears of cereal, and a separating unit 30 which is connected downstream of the threshing unit 20. The grains after separation by the separating device 30 pass to a grain cleaning apparatus 40.

The combine harvester has a front elevator housing 12 at the front of the machine for attachment of a crop cutting head (known as the header, not shown). The header when attached serves to cut and collect the crop material as it progresses across the field, the collected crop stream being conveyed up through the elevator housing 12 into the threshing unit 20.

In the example shown by FIG. 1, the threshing system 20 is a tangential-flow ‘conventional’ threshing system, i.e. formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

Such a threshing system 20 typically comprises a rotor beneath which is mounted a concave. The concave may have different sections along its length, and the first section to receive the crop material may have a releasable concave, or else the whole length of the concave may be releasable. The separating function involves conveying the crop stream rearwardly in a ribbon passing along a spiral path.

There are also axial threshing systems, i.e. formed by rotating elements with an axis of rotation in the longitudinal direction (direction of travel). For example, the threshing section may have axially-aligned rasp bars spaced around the front section whilst the separating section has separating elements or fingers arranged in a pattern, e.g. a spiral pattern, extending from the rasp bars to the rear of the rotor.

The operation of the combine harvester may be controlled by a control system (not shown). The control system may receive input from a user interface and/or sensing apparatus and control the operation of the various units and apparatus responsive to the received input.

The combine harvester 10 may also comprise a user support 90, e.g. a cab, for housing an operator/individual. The user support will often contain a user interface to allow the operator/individual to influence or control the operation of the elements of the combine harvester (e.g. via the control system). The user interface may also provide information about the combine harvester and/or the status of the combine harvester.

The threshing unit 20, separating device 30 and grain cleaning apparatus 40 are shown in more detail in FIG. 2.

FIG. 2 shows one particular design for a threshing system 20, namely an axial threshing (and separating) system. This is distinct from the tangential-flow threshing system illustrated in FIG. 1. The threshing unit 20 includes a rotating, tangential-flow, threshing cylinder 22 and a concave-shaped grate 24, sometimes simply called a concave. The threshing cylinder 22 includes rasp bars (not shown) which act upon the crop stream to thresh the grain or seeds from the remaining material, the majority of the threshed grain passing through the underlying grate 24 and onto a stratification pan 42 (also known as the grain pan), which for convenience is in this disclosure considered to be part of the grain cleaning apparatus 40.

The initial threshing creates a flow of grain to a stratification pan 42. The separating function further downstream of the threshing system serves to separate further grain from the crop stream and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 does not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 is in the form of a grain cleaning unit 50. The grain cleaning unit 50 remove this unwanted material thus leaving a clean sample of grain to be delivered to the tank.

The grain cleaning unit 50 comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The general flow of material is as follows. The grain passing through the concave 24 falls onto the front of stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the concave further back falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and is conveyed as indicated by arrow B.

The combined crop streams thus progress rearwardly towards a rear edge of the stratification pan 42. Whilst conveyed across the stratification pan 42, the crop stream, including grain and MOG, undergoes stratification wherein the more dense grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the grain to pass through the chaffer onto an underlying second sieve 56.

The chaffer 54 is coarser (with larger holes) than second sieve 56. Grain passing through chaffer 54 is incident on the lower sieve 56 which is also driven in an oscillating manner and serves to remove tailings from the stream of grain before being conveyed to on-board tank (not shown) by grain collecting auger 70 which resides in a transverse trough 70 at the bottom of the grain cleaning unit 50. Tailings blocked by sieve 56 are conveyed rearwardly by the oscillating motion thereof to a rear edge from where the tailings are directed to the returns auger 60 for reprocessing in a known manner. The grain is for example smaller and denser and generally more aerodynamic than MOG, therefore, less susceptible to being conveyed rearward by the chaffer/sieve and/or blown out of the rear of the machine by the air stream of the cleaning fan, passing upward and rearward, through the chaffer/sieve.

The grain collecting auger 70 delivers the grain to a grain tank, and a grain unloading system enables the grain to be removed from the grain tank.

The operation of the various units and elements of the combine harvester may be controlled by a control unit (not shown). For instance, the control unit may modify one or more operational components of the combine harvester.

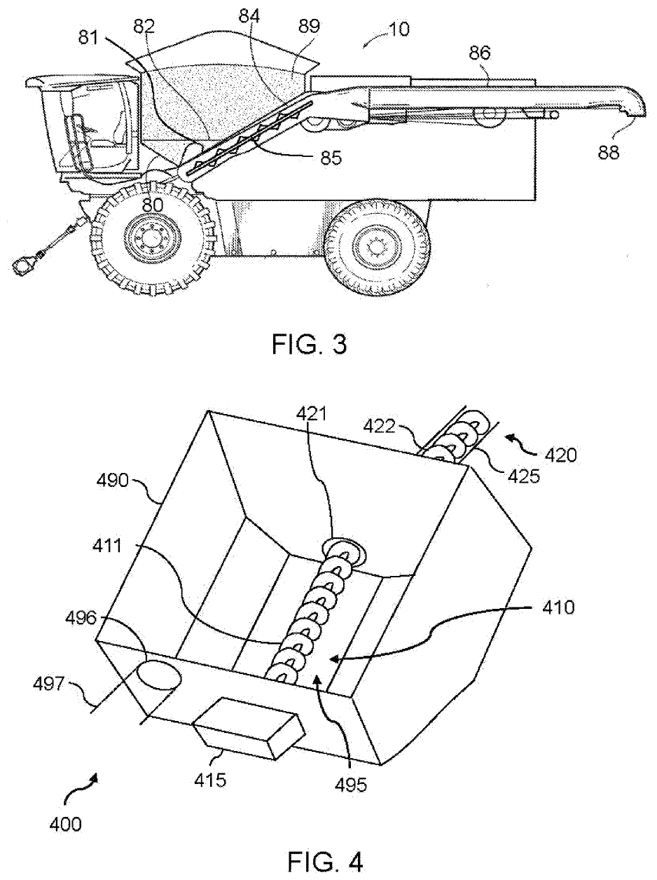

FIG. 3 provides an overview of a grain unloading system for the combine harvester 10. The cleaned grain 89 delivered by the grain processing system explained with reference to FIGS. 1 and 2 is delivered by the grain collecting auger which conveys the grain 89 to an onboard grain bin 80 located at the top of the combine harvester 10.

A grain unloading system is used to unload the onboard grain bin 80. The grain unloading system is formed of a cross auger system (not shown) and an unloading auger system. The cross auger system (together with gravity) moves grain 89 across the grain bin 80 to the unloading auger system. The unloading auger system receives the grain and expels the grain out of the grain bin.

In this example, the unloading auger system comprises an intake 81, here: positioned in a sump 82 or lower portion of the grain bin 80. The unloading auger system also comprises an unloading auger conveyor 84 that conveys the grain up and away from the grain bin 80, towards an outlet 88. The conveyed grain is then expelled out of the outlet 88. The outlet 88 may be formed or shaped as a grain nozzle to aid in directing the flow of grain. The expelled grain may, for instance, be expelled into a transport vehicle, trailer or other external grain store.

The unloading auger system may comprise a housing 86 or tube that houses the unloading auger conveyer 84 and defines the intake 81 and/or the outlet 88, e.g., as opposing ends of a lumen that spans though the housing.

The housing may be pivotally mounted on the chassis such that it can be pivotally rotated from a storage position alongside the combine harvester 10 as seen in FIG. 3 to an offload or discharge position away from the grain bin 80.

The housing may be formed from an inner riser section 84 and an outer transport section 86. A first end of the inner riser section 84 connects the intake 81 to the sump 82 or lower portion of the grain bin 80. The outer transport section 86 defines the outlet 88, e.g., in the form of a nozzle, at its outer end to direct the flow of grain into an external grain store. The inner riser section 84 also houses the unloading auger conveyor 85 with a shaft and helical flights that rotate in the inner riser section 84 to lift the grain to the outer transport section.

This disclosure relates to the design of the grain unloading system, and more particularly to the design and operation of the cross auger system.

For improved contextual understanding, FIG. 4 schematically illustrates a perspective view of a portion of an example grain unloading system 400. The grain unloading system 400 comprises a cross augur conveyor 410, an unloading auger system 420 and a grain bin 490.

The cross auger conveyer 410 is configured to receive grain and move the received grain towards the unloading auger system 420. In the illustrated example, the unloading auger system 420 comprises an intake 421 for receiving grain. The cross auger conveyer is configured for moving the grain towards this intake.

Generally, the cross auger conveyor is positioned to lie in a horizontal plane when in use. In the context of the present invention, a horizontal plane is any plane parallel to a plane on which the wheels of a combine harvester (carrying the cross auger conveyor) lie.

The cross auger conveyor is formed of a helical portion 411 configured to receive grain and a motor 415 configured to controllably rotate the helical portion. The helical portion acts in the manner of an Archimedes screw to move grain towards the unloading auger system as it rotates under the control of the moto 415.

In the illustrated example, the cross auger conveyor 410 is housed in the grain bin, and is specifically positioned in a lower portion 495 or sump of the grain bin 490. This allows gravity to move grain towards the cross auger conveyor 410 for subsequent movement towards the unloading auger system 420. The sides of the grain bin 490 may be sloped, to direct the travel of descending grain towards the cross auger conveyor, specifically the helical portion of the same.

Although only a single helical portion is illustrated, it will be appreciated that a cross auger system may comprise a plurality of different helical portions for moving grain towards the unloading auger system 420, e.g., towards an intake 421. The motor 415 may control the rotation of each helical portion individually/separately or simultaneously.

The unloading auger system 420 comprises an intake 421 configured to receive grain moved by the cross auger; an outlet (not shown) for expelling grain from the unloading auger; and an unloading auger conveyor 422 for moving grain from the intake to the outlet. The unloading auger system may also, as illustrated, comprise a housing 425 that houses the unloading auger conveyer 422

It will be appreciated that the unloading auger system 420 may comprise its own motor or motor system for driving the unloading auger conveyor 422. Preferably, the operation or control of the motor for the unloading auger conveyor is separate to that of the motor for the cross auger system, but this is not essential.

FIG. 4 also illustrates how the grain bin 490 may comprise a grain receiving aperture for receiving grain from a grain collecting auger 497. The operation of the grain collecting auger has been previously described.

The present disclosure proposes the use of a torque restriction system for restricting the load torque of the cross auger conveyor to be less than or equal to a predetermined maximum load torque. The load torque of the cross auger conveyor may be the load torque of the motor 415 of the cross auger conveyor 410.

More particularly, the torque restriction system is configured to monitor the load torque of the cross auger conveyor and restrict, responsive to the magnitude of the monitored load torque, the magnitude of the load torque to less than or equal to a predetermined maximum load torque.

The predetermined maximum load torque is adjustable. This allows the system to adjust the predetermined maximum load torque for different environments and/or crops to be moved using the cross auger conveyor. For instance, different crop types would benefit from different maximum allowable torques. As an example, a load torque would be higher for rice (as it is a hard to unload crop, but stands up well to damage) than for grass seed or edible bean crops (which benefit from a lower torque value to avoid/reduce damage).

The value of the predetermined maximum load torque is preferably lower than a maximum permissible load torque for the cross auger conveyor, e.g., a load torque that defines a maximum allowable load torque for operation of the motor for the cross auger conveyor. In particular, the predetermined maximum load torque is preferably below, e.g., no more than 75% the value of, the maximum operational load torque for operation of the motor and/or driving system for the motor.

The restricting may take place by reducing a speed (e.g., RPM) of the cross auger conveyor, e.g., of the motor of the cross auger conveyor. It will be appreciated that reducing a speed of the cross auger conveyor will inherently reduce a load torque. This will correspondingly slow the rotation of the helical portion of the cross auger conveyor and reduce the amount of material fed (per unit time) by the cross auger conveyor to the unloading auger system.

The load torque of the cross auger conveyor will respond to the weight of the harvested grain that is moved by the cross auger conveyor. By restricting the load torque of the cross auger conveyor, it is therefore possible to automatically control the rate of grain flow into the unloading auger system for different crop weights (e.g., different types of crops or different moisture levels) without the need for dedicated user input and/or crop monitoring techniques or devices. For instance, grain flow rate may be reduced for heavier crops and increased for lighter crops. This strategy can prevent or reduce damage to the unloading auger system, e.g., that would be otherwise caused by the increase or change in weight if crops are switched from light to heavy crops that are moved at a same flow rate.

The maximum load torque may be a load torque that supplies the unloading auger system with grain of a particular weight at a grain flow rate such that the total weight of (all) grain being moved by the unloading auger system is within an operational margin or range of the unloading auger system. The value of the maximum load torque may therefore vary for different combine harvesters or configurations of the unloading auger system.

As an example, rice is a hard to unload crop that would benefit from a similar torque value to wheat and corn, but would result in the cross auger spinning slower to not over load the unloading auger system. Grass seed or edible bean crops may want a lower torque value set to avoid damage to the grain that could result in a lower price per bushel of the grain.

Adjusting the predetermined maximum load torque may be performed responsive to an input signal provided to the torque restriction system. Thus, the torque restriction system may be configured to receive an input signal and set the predetermined maximum load torque responsive to the input signal. The input signal may, for instance, be provided by a processing system of the combine (or other device carrying the control system) and/or a user input. In one example, the input signal is an electrical signal. In another example, the input signal is a manual signal.

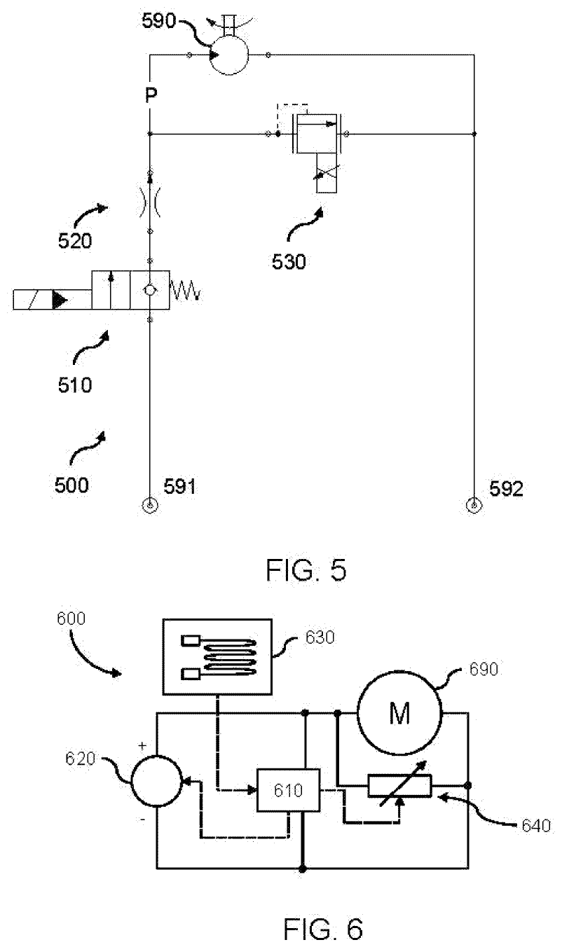

FIG. 5 is a simplified schematic diagram illustrating a control system 500 for controlling a motor 590 for a cross auger conveyor. It will be appreciated that the motor 590 does not form part of the control system 500 for the motor.

In this example, the motor 590 is a hydraulically driven motor, and the interconnecting lines of the control system 500 represent hydraulic pipes or hoses. A hydraulic pressure P applied to or provided to the hydraulically driven motor controls the rotation speed of the motor (and its corresponding helical portion(s)).

The control system 500 comprises an (optional) solenoid valve 510. The solenoid valve controls whether or not hydraulic fluid is permitted to flow from a pressurized source 591 to the motor 590. The hydraulic fluid (after driving the motor 590) is returned to a tank 592 of hydraulic fluid. The operation of the solenoid valve may be controlled based on whether there is a need to operate the cross auger conveyor, e.g., whether there is a desire to unload any grain in the grain bin. To save energy, the solenoid valve may prevent the flow of hydraulic fluid to the motor 590 when unloading is not desired.

The control system 500 also comprises a pressure compensated flow regulator 520, such as a pressure compensated flow control valve. This regulator controls the flow of fluid to the motor, e.g., to regulate or maintain the fluid flow to the motor with the aim of maintaining a particular rotation speed of the motor 590 (and its corresponding helical portion(s)). In this way, the regulator 520 may attempt to maintain a same speed of rotation for different torque loads of the cross auger conveyor. This has previously been seen as an advantage for consistent operation of the cross auger conveyor and avoidance of sudden changes in the speed of grain flow to the unloading auger system due to natural pressure drops of a hydraulic system.

The purpose of the pressure compensated flow regulator 520 is if pressures increase or decrease from other functions or devices that make use of the same pump or hydraulic fluid flow (such as movement of the header or rotation of other augur systems. For instance, if a header lift asks for 3000 psi while the cross auger conveyor is operating at 1000 psi, then the pressure drop through item 510 would increases so flow to the header would increase accordingly. The regulator 520 throttles back to maintain a constant flow to the motor 590 that won't (significantly) change if other pump actions change pressure.

However, the present invention recognizes that maintaining a constant speed for the motor can damage the cross auger conveyor and/or unloading auger system if crops of different weights (and/or amount of crop) are moved by cross auger conveyor.

There is proposed a torque restriction system 530, which monitors the load torque of the cross auger conveyor and restricts, responsive to the magnitude of the monitored load torque, the magnitude of the load torque to less than or equal to a predetermined maximum load torque.

For a hydraulically driven motor, the pressure drop across the motor directly relates to the torque output, e.g., is proportional to the torque output. Thus, it is possible to use (for a hydraulically driven motor) a (proportional) electronically controlled relief valve 530 that restricts or limits the pressure drop across the motor in order to control the load torque of the motor by providing an alternative path for fluid flow to the tank when a pressure exceeds a particular value.

Thus, the proportional relief valve effectively acts to monitor the load torque of the motor (here: monitor pressure drop) and restrict the load torque as it approaches a predetermined maximum load torque. Put another way, the torque restriction system 530, in the form of a (proportional) relief valve, is configured to reduce the hydraulic pressure provided to the hydraulically driven motor responsive to the magnitude of the monitored load torque approaching or reaching the predetermined maximum load torque.

Thus, the torque of the cross auger conveyor can be controlled by having a proportional pressure relief control valve that controls the pressure drop across the motor which directly relates to the torque output.

The proportional relief valve therefore acts as both a hydraulic pressure monitor and the mechanism for reducing the hydraulic pressure provided to the motor 590.

An alternative to using a relief valve 530 could be to use a controllable flow regulator. For instance the flow regulator 520 could comprise a controllable flow regulator. A hydraulic pressure monitor could monitor the hydraulic pressure provided to the motor (e.g., producing an electrical signal responsive thereto) which is used as feedback for controlling the amount of fluid permitted to flow through the flow regulator.

The general procedure for the control system 500 illustrated in FIG. 5 may therefore be as follows: 1) the solenoid valve 510 is energized to start the circuit 2) the relief valve 530 is ramped up to the pressure wanted 2) flow goes through the flow regulator 520 and goes to the motor 590 4) if the pressure going into the motor 590 gets too high such that it exceeds a relief value, some of the flow will go across the relief valve 530 until the pressure provided to the motor 590 (and therefore rpm of the motor) reduces to a value low enough to be below the relief value.

The previously described example makes use of the control of a hydraulically driven motor. However, in other embodiments, the motor is an electrically driven motor. Generally, the power provided to an electrically driven motor governs the rotation speed of the electrically driven motor.

The control system 500 may comprise other elements and/or features that are not illustrated for the sake of clarity, e.g., features for driving or powering other elements of the combine harvester such as the header or other augers and/or flow control features.

FIG. 6 is a simplified schematic diagram illustrating another control system 600 for controlling a motor 690 for a cross auger conveyor. It will be appreciated that the motor 690 does not form part of the control system 600 for the motor.

In this example, the motor 690 is an electrically driven motor (i.e., an electrical motor). The interconnecting lines of the control system 600 represent electrical wires configured for carrying power or signals. A power applied to or provided to the electrical motor controls the rotation speed of the motor (and its corresponding helical portion(s)).

In this scenario, the torque restriction system may comprise a controller 610 configured to control the power provided to the motor 690. This may, for instance, comprise controlling the power provided by a power supply 620 to the motor 690 responsive to a torque sensing signal ST that carries a measure of the load torque of the cross auger conveyor. The torque restriction system may, for instance, comprise one or more strain sensors 630 for monitoring the load torque of the motor. Other suitable load torque sensors could be used in alternative embodiments.

An alternative to controlling the power provided by a power supply 620 is to use a controllable power bypass, e.g., control the resistance of a variable resistor 640, to control the power provided or supplied to the motor 690.

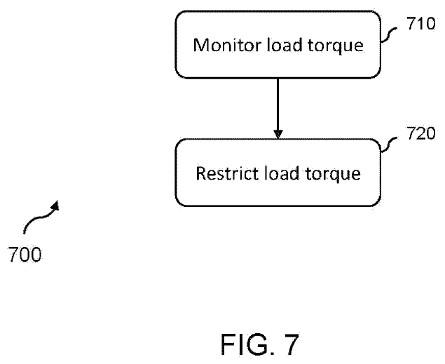

FIG. 7 is a flowchart illustrating a method 700 for controlling the operation of a cross auger system for moving grain across a grain bin towards an unloading auger. The cross auger system comprises a cross auger conveyor configured to receive grain and move the received towards an unloading auger.

The method comprises a step 710 of monitoring the load torque of the cross auger conveyor. The method also comprises a step 720 of restricting the magnitude of the load torque to less than or equal to a predetermined maximum load torque.

Techniques and elements capable of performing steps 710 and 720 have been previously described.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. If a computer program is discussed above, it may be stored/distributed on a suitable medium, such as an optical storage medium or a solid-state medium supplied together with or as part of other hardware, but may also be distributed in other forms, such as via the Internet or other wired or wireless telecommunication systems. If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa. Any reference signs in the claims should not be construed as limiting the scope.

All references cited herein are incorporated herein in their entireties. If there is a conflict between definitions herein and in an incorporated reference, the definition herein shall control.

1. A cross auger system for moving grain across a grain bin towards an unloading auger system, the cross auger system comprising:
a cross auger conveyor configured to receive grain and move the received grain towards an unloading auger system; and
a torque restriction system configured to monitor the load torque of the cross auger conveyor and restrict, responsive to the magnitude of the monitored load torque, the magnitude of the load torque to less than or equal to a predetermined maximum load torque, wherein the value of the predetermined maximum load torque is adjustable.

2. The cross auger system of claim 1, wherein the cross auger conveyor comprises:
at least one helical portion configured to receive grain; and
a motor configured to controllably rotate each helical portion so as to control the movement of grain along each helical portion, wherein the load torque of the motor represents the load torque of the cross auger conveyor.

3. The cross auger system of claim 2, wherein:
the motor is a hydraulically driven motor, wherein a hydraulic pressure provided to the hydraulically driven motor controls the rotation speed of each helical portion; and
the torque restriction system is configured to reduce the hydraulic pressure provided to the hydraulically driven motor responsive to the magnitude of the monitored load torque approaching or reaching the predetermined maximum load torque.

4. The cross auger system of claim 3, wherein the torque restriction system comprises an electronically controlled relief valve configured to controllably reduce the hydraulic pressure responsive to the magnitude of the monitored load torque approaching or reaching the predetermined maximum load torque.

5. The cross auger system of claim 3, wherein:
the torque restriction system comprises a controllable flow regulator configured to control the hydraulic pressure provided to the hydraulically driven motor; and
the flow regulator controls the hydraulic pressure responsive to the monitored load torque so as to restrict the magnitude of the load torque to less than or equal to the predetermined maximum load torque.

6. The cross auger system of claim 3, wherein the torque restriction system comprises a hydraulic pressure monitor configured to monitor, as a measure of the load torque, the hydraulic pressure provided to the hydraulically driven motor.

7. The cross auger system of claim 2, wherein:
the motor is an electrically driven motor; and
the torque restriction system is configured to reduce the power provided to the electrically driven motor responsive to the magnitude of the load torque approaching or reaching the predetermined maximum load torque.

8. The cross auger system of claim 7, wherein the torque restriction system comprises one or more strain sensors for monitoring the load torque of the motor.

9. The cross auger system of claim 1, wherein, in use, the cross auger conveyor lies in a horizontal plane.

10. A grain unloading system comprising:
the cross auger system of claim 1; and
an unloading auger system comprising:
an intake configured to receive grain moved by the cross auger;
an outlet for expelling grain from the unloading auger; and
an unloading auger conveyor for moving grain from the intake to the outlet.

11. The grain unloading system of claim 10, further comprising the grain bin for holding grain, wherein:
the cross auger conveyor of the cross auger system is housed within the grain bin;
the intake of the unloading auger system is located within the grain bin; and
the outlet of the unloading auger system is located outside of the grain bin.

12. The grain unloading system of claim 10, further comprising a housing that houses the entirety of the unloading auger conveyer and defines the intake and outlet.

13. A combine harvester comprising the cross auger system of claim 1.

14. A combine harvester comprising the grain unloading system of claim 10.

15. A method for controlling the operation of a cross auger system for moving grain across a grain bin towards an unloading auger system, wherein the cross auger system comprises a cross auger conveyor configured to receive grain and move the received towards the unloading auger system, the method comprising:
monitoring the load torque of the cross auger conveyor; and
restricting the magnitude of the load torque to less than or equal to a predetermined maximum load torque, wherein the predetermined maximum load torque is adjustable.
